(19) United States
(12) Patent Application Publication
(10) Pub. No.: US 2008/0031243 A1
(43) Pub. Date: Feb. 7, 2008

(54) Migration of Message Topics over Multicast Streams and Groups

(76) Inventors: Gidon Gershinsky, Haifa (IL); Zvi Har'el, Haifa (IL); Avraham Harpaz, Haifa (IL); Nir Naaman, Haifa (IL); Yoav Tock, Nesher (IL)

Correspondence Address: IBM CORPORATION, T.J. WATSON RESEARCH CENTER, P.O. BOX 218, YORKTOWN HEIGHTS, NY, 10598, US

(21) Appl. No.: 11/461,495

(22) Filed: Aug. 1, 2006

(51) Int. Cl. H04L 12/56

(52) U.S. Cl. 370/390; 370/465

(57) ABSTRACT

A method for migrating data transmitted from a transmitter to a receiver over a first stream to a second stream in a reliable multicast system is provided. The method comprises transmitting a first message from the transmitter to the receiver over the first stream to notify the receiver that a first data flow transmitted on the first stream will be transmitted on the second stream. The transmitter transmits a second message to the receiver over the second stream after a second threshold has expired. The receiver tunes to the second stream based on the second message. The transmitter transmits a third message to the receiver over the first stream after a third threshold has expired to notify the receiver that transmission of the first data flow over the first stream will be terminated. The transmitter then transmits a fourth message from the transmitter to the receiver over the second stream after a fourth threshold has expired.

### COPYRIGHT & TRADEMARK NOTICES

A portion of the disclosure of this patent document contains material which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to broadcasting content over a communication network and, in particular to a system and method for migrating message topics among multiple multicast streams, and migrating multicast data streams among multiple multicast groups.

### BACKGROUND

A large-scale data multicast system may be used to disseminate content related to a great variety of topics to multitudes of receivers (e.g., users). For example, many financial and news reporting conglomerates now employ elaborate multicasting/broadcasting schemes to deliver up-to-date quotes and information to their subscribers in real-time. Broadcasting schemes are generally more favorable than unicast methods, as broadcasting is a more efficient method for delivering messages to large groups.

Referring to FIG. 1, the broadcast of content from a source to a group of users is typically represented by information flows (i.e., data streams). Each data stream may carry one or more messages. The messages are delivered to particular users or user groups. Typically, different users are interested in different topics, so several data streams will have to be sent to a single user. In a large-scale multicast system, individual users can be interested in the same topic, so a single data stream will have to be sent to several users.

Thus, the challenge in multicasting is to efficiently combine information on various topics in one or more data streams that are deliverable to a group of users interested in particular topics. For example, in a securities trading system, each user may be interested in receiving quotes for a variety of different stocks. Therefore, each user may receive several data streams, such that each stream provides information about one or more stocks. Yet, since each data stream will have to be delivered to several users, multitudes of overlapping data streams may be generated and transmitted.

Typically, a topic is an information flow associated with a single stream, where each stream is associated with a single multicast group. Since multicast streams and groups are associated with limited resources, when the number of topics is greater than the number of streams, multiple topics are transmitted over a single stream And, when the number of streams is larger than the number of groups, multiple streams are transmitted to a single group. As shown in FIG. 1, by way of example, each topic (e.g., T1, T2, T3, . . . ) is mapped to a stream (e.g., S1, S2, S3, . . . ); and each stream is mapped to a multicast group (e.g., G1, G2, G3, . . . ).

Some mapping schemes are implemented based on the consumer interest and topic rate (i.e., the rate at which data is broadcasted on a topic). The consumer interest and topic rate both change depending on the interest of individual users and availability of broadcasting resources. Therefore, certain mapping schemes monitor the interest and topic rate to update the mappings in order to maintain an appropriate level of performance and ensure proper multicasting.

Since many topics are multicast in real-time, it is increasingly important to change the mapping without disrupting the multicasting streams. The conventional multicast schemes fail to provide an efficient means for changing multicast mappings so that messages are not lost or duplicated during runtime. Multicasting methods and systems are needed to overcome the aforementioned shortcomings.

### SUMMARY

The present disclosure is directed to a system and corresponding methods which facilitate migration of message topics over reliable multicast streams, and the migration of reliable multicast streams over multicast groups.

Certain aspects, advantages, and novel features of the invention have been described herein by way of example. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, a method for migrating data flows transmitted from a transmitter to a receiver over a first stream to a second stream in a reliable multicast system is provided. The method comprises transmitting a first message from the transmitter to the receiver over the first stream to notify the receiver that a first data flow transmitted on the first stream will be transmitted on the second stream. The transmitter transmits a second message to the receiver over the second stream after a second threshold has expired.

The receiver uses the second message to synchronize with the second stream. The transmitter transmits a third message to the receiver over the first stream after a third threshold has expired to notify the receiver that transmission of the first data flow over the first stream will be terminated. The transmitter then transmits a fourth message from the transmitter to the receiver over the second stream after a fourth threshold has expired to indicate to the receiver successful migration of the first data flow from the first stream to the second stream. Transmitter transmits the first data flow on the second stream after a first threshold has expired.

In one embodiment, the second message comprises a beacon allowing the receiver to tune itself with the second stream, and the third message indicates the end of transmission of the first data flow over the first stream. The first data flow may comprise a plurality of topics. In one or more embodiments, the receiver provides feedback to the transmitter to indicate status of receipt of the first, second, third or fourth messages. The first data flow, in one embodiment, may be transmitted over the second stream, in response to the transmitter receiving the feedback from the receiver, if the first threshold has not yet expired.

In accordance with another embodiment, a method for migrating a data stream transmitted from a transmitter to a receiver in a first multicast group is provided. The method comprises transmitting a first message from the transmitter to the receiver in the first multicast group to notify the receiver that a first data stream transmitted to the first multicast group will be transmitted to a second multicast group; and transmitting the first data stream to the second multicast group after a first threshold has expired.

One or more of the above-disclosed embodiments, in addition to certain alternatives, are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary multicasting environment, in accordance with one embodiment.

FIG. 2 illustrates multiple migration layers implemented to manage migration of topics and stream, in accordance with one embodiment.

FIG. 3A is a flow diagram showing messages transmitted over one or more data streams, in accordance with a preferred embodiment.

FIG. 3B is a flow diagram showing messages transmitted to one or more multicast groups, in accordance with a preferred embodiment.

FIG. 4 illustrates exemplary actions taken by a transmitter during a flow migration, in accordance with one embodiment.

FIG. 5 illustrates exemplary actions taken by a transmitter during a stream migration, in accordance with one embodiment.

FIG. 6 illustrates a group response collection mechanism, in accordance with one embodiment.

FIGS. 7A and 7B are block diagrams illustrating how a receiver group may be calculated during flow and stream migration, respectively, in accordance with one or more embodiments.

FIGS. 8A and 8B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects in accordance with one or more embodiments.

### DETAILED DESCRIPTION OF PREFERRED EMBODIMENTS

The present disclosure is directed to systems and corresponding methods which facilitate migrating multicast data flows among multiple multicast streams, and migrating multicast data streams among multiple multicast groups.

In the following, numerous specific details are set forth to provide examples of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

In accordance with one aspect of the invention, the migration process is implemented to maintain message ordering in data streams and to limit message duplication or data loss. In the following, the migration process in accordance with an exemplary embodiment is described as applicable to a reliable multicast protocol. It is noteworthy, however, that the scope of the invention should not be construed as limited to the exemplary embodiments provided herein, but should be broadly construed to incorporate all other functional or structural equivalents or substitutes thereof.

In one exemplary embodiment, reliable multicast transport protocol (RMTP), Pragmatic General Multicast (PGM) or other type of reliable multicast protocol may be used for broadcasting data over a data network. RMTP provides sequenced, lossless delivery of a data stream from one sender to a group of receivers. PGM, in one embodiment, provides ordered, duplicate-free, multicast data delivery from multiple sources to multiple receivers, for example.

The following publications, the entire content of which is incorporated herein by reference, provide more details about reliable multicasting methods: J. W. Atwood, “A classification of reliable multicast protocols”, IEEE Network, Vol. 18, pp. 24-34, May/June 2004; T. Speakman et al., “PGM reliable transport protocol specification,” RFC 3208, December 2001; J. Gemmell, T. Montgomery, T. Speakman, N. Bhaskar, and J. Crowcroft, “The PGM reliable multicast protocol,” IEEE Network, vol. 17, no. 1, pp. 16-22, January/February 2003).

The reliable multicast protocol is utilized to define data streams and multicast sessions which, preferably, define the basic transport layer entities. Each stream may be associated with a single multicast group, for example. The following publications, the entire content of which is incorporated by reference herein, provide more details about various mapping schemes in a multicasting environment:

M. Adler, Z. Ge, J. F. Kurose, D. Towsley, and S. Zabele, “Channelization problem in large scale data dissemination,” Int'l Conf. on Network Protocols, 2001, pp. 100-109. T. Wong, R. H. Katz, and S. McCanne, “A preference clustering protocol for large-scale multicast applications,” Networked Group Communication, 1999, pp. 1-18; T. Wong, R. H. Katz, and S. McCanne, “An evaluation of preference clustering in large-scale multicast applications,” Proc. of IEEE INFOCOM (2), 2000, pp. 451-460; Y. Tock, N. Naaman, A. Harpaz, G. Gershinsky, “Hierarchical Clustering of Message Flows in a Multicast Data Dissemination System”, The 17th IASTED International Conference on Parallel and Distributed Computing and Systems, November 2005.

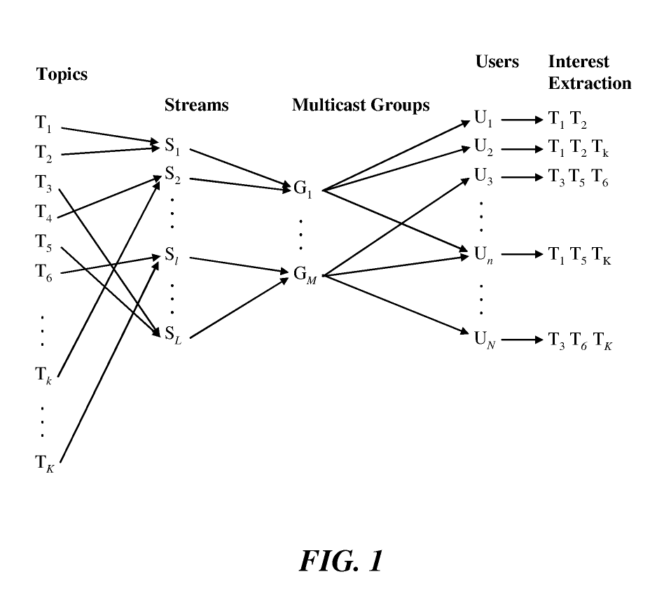

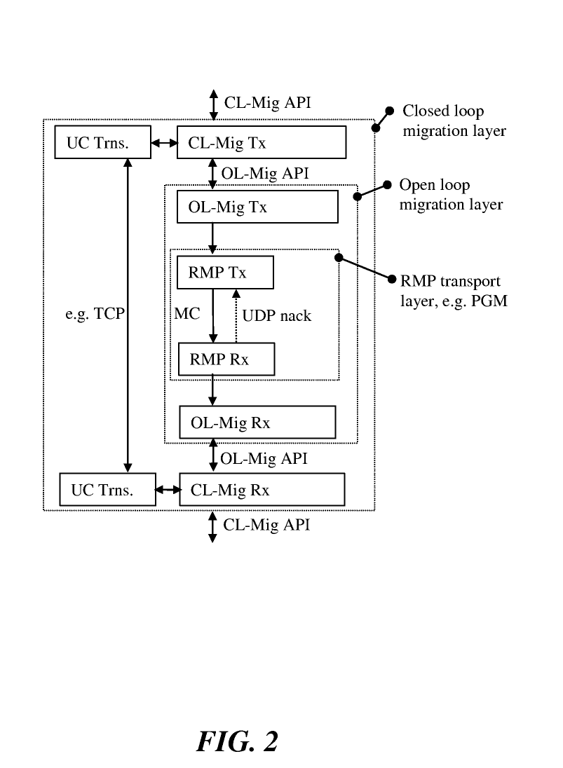

Referring to FIG. 1, in one embodiment, a reliable multicast protocol (RMP) class is used to broadcast messages on various topics (e.g., T1, T2, T2, . . . ) over a communication network to several users (U1, U2, U3, . . . ) in different multicast groups, using multiple data streams (e.g., S1, S2, S3, . . . ). As shown in FIG. 2, the migration mechanism of the reliable multicast protocol of the present invention preferably comprises multiple complementing layers of protocols (e.g., an open-loop protocol and a closed loop protocol).

The open loop protocol uses a reliable multicast protocol to send one or more in band signals to one or more users (i.e., receivers (Rx)). In band signals are control messages sent over the reliable multicast protocol streams that are used to transfer data to the receivers. In band signals notify the receivers of a change in mapping scheme, and instruct the receivers to perform one or more actions in preparation for receiving messages according to the new mapping. In an exemplary embodiment, the open loop protocol, for the purpose of efficiency, does not allow direct feedback from the receivers to the entity that controls the change in mapping (e.g., the transmitter (Tx)).

Referring to FIG. 2, in one embodiment, the closed loop protocol is implemented on top of the open loop protocol. The closed loop (CL) protocol utilizes information generated by the open loop (OL) protocol to maintain a certain level of quality of service (QoS) by providing feedback from the receivers to the transmitter. In one embodiment, the closed loop protocol comprises a mechanism that can identify the receivers affected by a change in mapping and enables the receivers to communicate with the transmitter by way of a point-to-point protocol (e.g., UDP, TCP).

TCP (Transmission Control Protocol) is a reliable transport protocol within the TCP/IP protocol suite that is used to ensure all transmitted data arrive accurately and intact. UDP (User Datagram Protocol) is a less reliable counterpart to TCP that is used when a reliable delivery is not needed or the overhead associated with processing a TCP is undesirable. UDP can be used for streaming and multicasting audio/video, voice over IP (VoIP) and videoconferencing, where there is limited time available for retransmitting erroneous or dropped data packets.

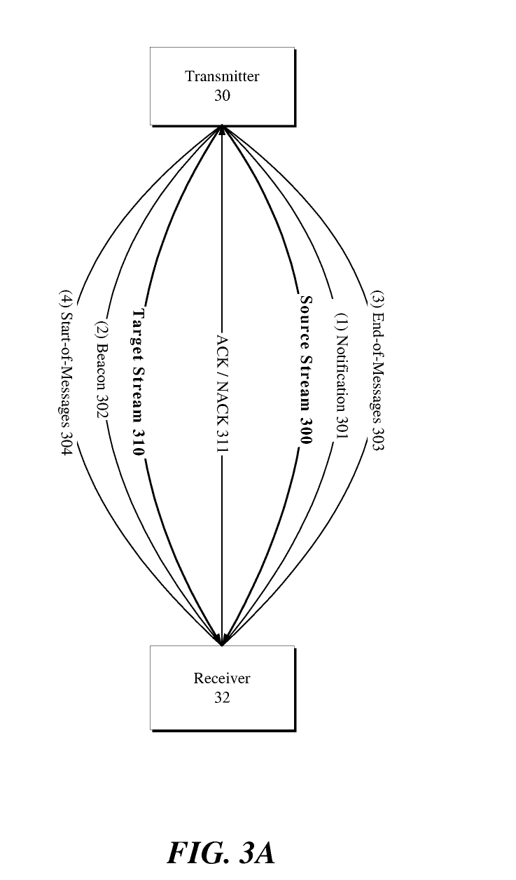

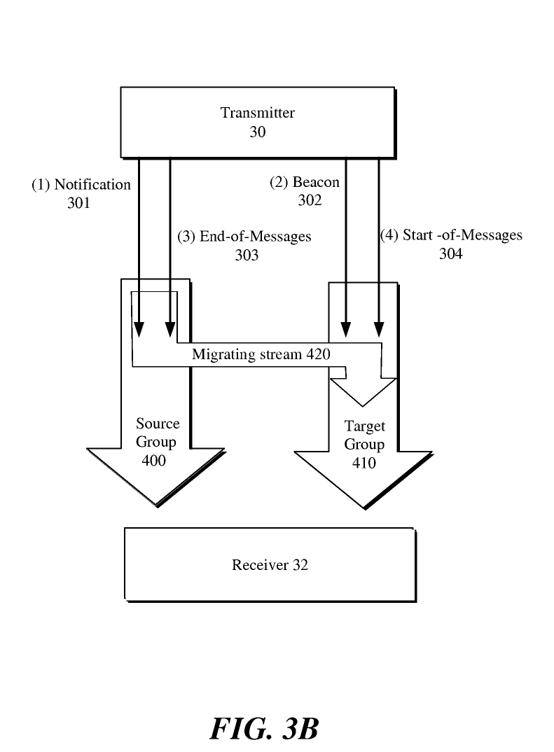

FIG. 3A is a flow diagram illustrating the flow of migration of a data flow from a first stream to a second stream and the related control messages transmitted between a transmitter 30 and a receiver 32. The source stream 300 represents a first data stream used to transmit a first set of topics from transmitter 30 to receiver 32, using a reliable multicast protocol. Target stream 310 represents a second data stream for transmitting a second set of topics from transmitter 30 to receiver 32.

The exemplary illustration in FIG. 3A is simplified for the purpose of clarity and brevity to show migration of a single data stream (i.e., topic). A person skilled in the art would understand that each of source stream 300 and target stream 310 may represent one or more data streams for transmitting one or more topics from one or more transmitters to one or more receivers. Thus, in the following, we discuss the migration of a single data flow, comprising one or more topics, from source stream 300 to target stream 310 with reference to FIG. 3A.

It should be noted, however, that more than one data flow may be transmitted from transmitter 30 to receive 32 over source steam 300. Thus, migration of one flow may be independent of other flows, in accordance with one or more embodiments. That is, when migration of a first flow from source stream 300 to target stream 310 is completed, transmitter 30 may continue to transmit other topics to receiver 32 over the source stream 300.

Referring to FIGS. 1 through 3, in the open loop protocol, source stream 300 or certain topics transmitted over source stream 300 may migrate to target stream 310 by way of transmitter 30 transmitting a first signal (e.g., notification 301) on source stream 300 to inform receiver 32 about a change in multicast mapping. A second signal (e.g., beacon 302) may be transmitted on target stream 310 to allow receiver 32 to tune into target stream 310 before data from source stream 300 is transmitted over target stream 310.

A third signal (e.g., end-of-messages 303) may be transmitted on source stream 300 to indicate that no further messages will be transmitted on source stream 300, or that certain topics will no longer be transmitted over source stream 300. And, preferably, a fourth signal (e.g., start-of-messages 304) may be transmitted on target stream 310 to indicate to receiver 32 that messages from the migrating data flow are being transmitted on target stream 310.

Depending on implementation, the first, second, third and fourth signals noted above may be transmitted more than once, in different orders than that described above, in periodic time intervals, and with predetermined delays to reduce the chances for error in case receiver 32 for some reason (e.g., problems due to network traffic, noise, physical route, etc.) fails to receive either of the first, second, third and fourth signals or other related control signals or data.

In certain embodiments, the first two signals (e.g., notification 301 and beacon 302) constitute a preparation phase, whereas the last two signals (e.g., end-of-messages 303 and start-of-messages 304) constitute a switch phase. The switch and preparation phase follow a certain process for transmitting and receiving the above signals in order to ensure proper migration and synchronization of source stream 300 to target stream 310.

In the preparation phase, transmitter 30 or other service in the open loop protocol system notifies receiver 32, by way of notification signal 301, of the change in mapping. Notification signal 301 may, for example, provide receiver 32 with identification information associated with target stream 310. Beacon signal 302 is preferably transmitted to allow receiver 32 and transmitter 30 synchronize data transmission, as provided in further detail below.

In the switch phase, transmitter 30 ceases to send messages over source stream 300 after end-of-messages signal 303 is transmitted. Thereafter, in accordance with one aspect of the invention, a start-of-messages signal 304 is transmitted before and/or after message transmission on target stream 310 has begun. This process provides additional assurance that receiver 32 is aware of the change in mapping.

In one or more embodiments, a delay is preferably implemented between the preparation and switch phases to enhance the likelihood that receiver 32 successfully follows transmitter's 30 instructions. For example, a five second delay may be implemented between transmitting the first notification signal 301 on source stream 300 (i.e., beginning of preparation phase) and transmitting end-of-messages signal 303 on source stream 300 (i.e., beginning of switch phase).

The delay allows receiver 32 to have sufficient time to reset certain properties and attributes to, for example, close the old data session associated with source stream 300 and open a new data session for receiving target stream 310. Accordingly, the open loop protocol is implemented to synchronize the data multicast between source stream 300 and target stream 310 by way of transmitting the above noted control signals and a time delay therebetween.

In the closed loop protocol, receiver 32 preferably informs transmitter 30 of receiver's 32 data reception state during the migration, by way of for example, a feedback message (e.g., ACK/NACK 311). Thus, if at least one receiver 32 fails to successfully detect the migration of data flows from source stream 300 (e.g., due to problems associated with the underlying multicast transport infrastructure) the closed loop protocol enables receiver 32 to detect and report such failures, by way of the feedback message.

In one embodiment, receiver 32 can confirm or deny the success of a remapping or migration process. To confirm, receiver 32 send an acknowledgment (e.g., ACK) in the feedback message. To deny, receiver 32 sends a non-acknowledgment (NACK) in the feedback message. The feedback message may be sent in response to receiver 32 receiving various control signals (e.g., first, second, third or fourth signal) or after a certain time threshold has expired. Thus, the successful completion of each segment or each phase of migration can be confirmed or denied by the mechanism of the closed loop layer.

In a certain embodiment, transmitter 30 uses the information in the feedback message to expedite the transition between the preparation phase and the switch phases, or the particular segments in each phase. For example, in response to determining that the initial phase of the migration was successful (e.g., receiver 32 acknowledging receipt of the first two signals), transmitter 30 may shorten a predetermined delay (e.g., 5 seconds) after which the second phase is initiated.

For example, the migration may be completed in a shorter amount of time if the predetermined time delay is shortened (e.g., from 5 seconds to 1 second). Under circumstances where multitudes of data flows (e.g., 1000 flows) are migrating sequentially, the above procedure will lead to significant time savings (e.g., 4 seconds per flow, or 4000 seconds, i.e., 11 hours total).

In another embodiment, in response to determining that a certain phase of the migration has been unsuccessful, or in response to determining that a certain signal has not been received by at least one receiver 32, the feedback information is used to identify the receivers that were unable to successfully receive a signal. Alternatively, the feedback information can be used to identify one or more receivers that are not successful in completing a migration, or even determine particular nodes in the network where migration cannot be completed.

Thus, feedback messages can be utilized to troubleshoot the multicast system and determine reasons for failure in migration or multicasting. Depending on implementation, a unicast protocol (e.g., TCP) may be used to transmit the feedback message from receiver 32 to transmitter 30. The feedback messages, depending on implementation and the migration phase may be transmitted over a dedicated control stream that is independent from source stream 300 or target stream 310, or a combination of said streams.

According to the above, in one embodiment, the closed loop protocol is implemented to complement the open loop protocol when a data flow migrates from a source stream to a target stream. The closed loop protocol provides a higher degree of reliability for successful migration of data streams by expediting the transition between the preparation phase and the switch phase, and identifying troublesome transmitters, receivers or migration routes.

It is noteworthy that in certain embodiments the open loop migration protocol may be used independently from the closed loop protocol, where no feedback is permitted or provided from the receivers to the transmitter. In the absence of the closed loop protocol, the migration process may not be completed as expeditiously. Instead, the system overhead will be reduced, as a portion of the system's bandwidth will not be dedicated to transmitting feedback messages between the receivers and transmitters.

Referring to FIG. 3B, in accordance with another aspect of the invention, the open and closed loop protocols discussed above can be also utilized to manage the migration of data streams (e.g. migrating stream 420) from one multicast group (e.g., source group 400) to another multicast group (e.g., target group 410). The general nature of protocols and phases for migration of data streams between multicast groups is similar to those disclosed above with respect to the migration of topics between data streams. That is, first, second, third and fourth control messages may be transmitted from transmitter 30 to receiver 32 for the purpose of efficiency and reliability.

For example, in the open loop protocol, certain data streams (e.g. migrating stream 420) transmitted to source group 400 may migrate to target group 410 by way of transmitter 30 transmitting a first signal (e.g., notification 301) on source group 400 to inform receiver 32 about a change in multicast mapping. A second signal (e.g., beacon 302) may be transmitted to target group 410 to allow receiver 32 to tune into target group 410 before data from source group 400 is transmitted to target group 410.

A third signal (e.g., end-of-messages 303) may be transmitted on source group 400 to indicate that no further messages will be transmitted to source group 400, or that certain streams will no longer be transmitted to source group 400. And, preferably, a fourth signal (e.g., start-of-messages 304) may be transmitted to target group 310 to indicate to receiver 32 that messages originally transmitted to source group 400 are being transmitted to target group 410.

As discussed with respect to the flow migration process, in the multicast stream migration process, the first two signals (e.g., notification 301 and beacon 302) may also constitute a preparation phase, whereas the last two signals (e.g., end-of-messages 303 and start-of-messages 304) may constitute a switch phase to ensure proper migration and synchronization of streams from source group 400 to target group 410.

In the preparation phase, transmitter 30 or other service in the open loop protocol system notifies receiver 32, by way of notification signal 301, of the change in grouping. Notification signal 301 may, for example, provide receiver 32 with identification information associated with target group 410. Beacon signal 302 is preferably transmitted to allow receiver 32 and transmitter 30 synchronize data transmission, as provided in further detail below.

In the switch phase, transmitter 30 ceases to send messages to source group 400 after end-of-messages signal 303 is transmitted. Thereafter, in accordance with one aspect of the invention, a start-of-messages signal 304 is transmitted before and/or after message transmission to target group 410 has begun. This process provides additional assurance that receiver 32 is aware of the change in grouping.

In one embodiment, at least one of the above control signals (e.g., notification signal 301, beacon signal 302, end-of-messages signal 303 or start-of-messages signal 304) may be transmitted to source group 400 or target group 410, over migrating stream 420 itself. Alternatively, one or more of the control signals may be transmitted over a dedicated control stream or a combination of dedicated and non-dedicated data or control streams.

In one or more embodiments, a delay is preferably implemented between the preparation and switch phases to enhance the likelihood that receiver 32 successfully follows transmitter's 30 instructions. Accordingly, the open loop protocol is implemented to synchronize the data multicast between source group 400 and target group 410 by way of transmitting the above noted control signals and a time delay therebetween.

In the closed loop protocol, receiver 32 preferably informs transmitter 30 of receiver's 32 data reception state during the migration, by way of for example, a feedback message (e.g., ACK/NACK 311). Thus, if at least one receiver 32 fails to successfully detect the migration of data topics from source group 400, the closed loop protocol enables receiver 32 to detect and report such failures, by way of the feedback message.

Depending on implementation and whether both open and closed loop protocols are used, the migration of data streams or change of data flow between various multicast groups may be managed for several levels of QoS, according to one or more embodiments. For example, where open loop protocol is utilized independent from the closed loop protocol (i.e., without feedback), the level of data loss and system overhead can be adjusted by controlling the transmission of first, second, third and fourth signals.

In one embodiment, not all four signals may be utilized. So transmitter 30 may be adjusted to, for example, send a single end-of-messages signal 303, and a single start-of-messages signal 304. In this manner, beacon signal 302 or notification signal 301 are not transmitted, so the additional level of assurance associated with transmitting the first and second signals is not provided. Thus, instead of initiating the migration, for example, 5 seconds after notification signal 301 is sent, migration may be initiated, for example, 5 seconds after end-of-messages signal 303 is sent.

A person of ordinary skill would appreciate that the transmission or lack of transmission of either of the first, second, third or fourth signals, or the associated time delay in initiating the migration, may be adjusted depending on implementation. Table 1 below illustrates some of the possible implementations for the use of said signals, in accordance to one or more embodiments, where X denotes whether or not a respective signal is transmitted.

TABLE 1

| First | Second | Third | Fourth |
|---|---|---|---|
| X | X | X | X |
| X | X | X | 0 |
| X | X | 0 | X |
| X | 0 | X | X |
| 0 | X | X | X |
| 0 | X | X | 0 |
| 0 | X | 0 | X |
| 0 | 0 | X | X |
| 0 | 0 | X | 0 |
| 0 | 0 | 0 | X |
| 0 | 0 | X | 0 |
| 0 | X | 0 | 0 |
| X | 0 | 0 | 0 |
| 0 | X | 0 | 0 |
| 0 | 0 | X | 0 |
| 0 | 0 | 0 | X |
| 0 | 0 | 0 | 0 |

In certain embodiments, X can be an integer greater than zero. Table 2, for example, defines an embodiment wherein the first signal is transmitted three times, and the third and fourth signals are each transmitted once, and the second signal is not transmitted at all.

TABLE 2

| First | Second | Third | Fourth |
|---|---|---|---|
| 3 | 0 | 1 | 1 |

The number of times a signal is transmitted, or the time delay associated with the transmission of each signal, may be determined and adjusted in real time, depending on system performance. Table 3, for example, illustrates the time delay associated with transmission of each signal, wherein the second signal is transmitted 0.5 seconds after the first signal, the third signal is transmitted 1.5 seconds after the second signal, and the fourth signal is transmitted 0.5 seconds after the third signal, for example.

TABLE 3

| Signal | Time of transmission, in seconds |
|---|---|
| Notification 301 | T |
| Beacon 302 | T + 0.5 |
| End-of-messages 303 | T + 2 |
| Start-of-messages 304 | T + 2.5 |

It is noteworthy that Table 3 is not illustrative of a specific order in which the first, second, third and fourth signals are transmitted. In other words, the signals may be transmitted in any order, or no order at all, without detracting from the scope of the invention. Further, a particular order of transmission, the values associated with the time delay, and number of transmissions for each control signal can be adjusted to provide a better QoS. For example, increasing the number of transmissions or the time delay can enhance QoS. These values can be adjusted in real-time by transmitter 30 depending on the change in system overhead and efficiency.

QoS can be further improved based on feedback messages transmitted by receiver 32 in the closed loop protocol. For example, the type and number of signals sent by transmitter 30 and the associated time delays may be controlled according to the feedback messages. Furthermore, certain messages or data can be retransmitted if the feedback message indicated data or signal loss. Even further, slow receivers or transmitters in the network may be identified and data steams can be managed by grouping or cross-coupling the slow receivers and/or transmitters for more efficient use of the network bandwidth.

In accordance with one embodiment, the open and closed loop protocols can be implemented to provided three QoS levels by way of utilizing (1) the open loop protocol, (2) the closed loop protocol with partial acknowledgement, and (3) closed protocol with full acknowledgement.

In the first level, the time delay between the preparation and switch phases is based on a predetermined timeout mechanism. As discussed earlier, receiver 32 does not send any acknowledgement to transmitter 30 upon receiving any of the first, second, third or fourth signals. In this embodiment, phase two is initiated after a predetermined time threshold (e.g., five seconds) expires. In this embodiment, receiver 32 is responsible for discovering failures and taking corrective action.

In the second level, receiver 32 sends feedback messages (e.g., ACKs) to confirm successful receipt of one or more of the first, second, third and fourth signals, but not all. As provided above, the feedback allows migration to take place as soon as the feedback messages are received by transmitter 30, rather than based on the expiration of a predetermined threshold. For example, in one embodiment, migration may take place when a predetermined number of the receivers acknowledge receipt of the first and second signal signals. Otherwise, migration takes place in accordance with the time delay. In this embodiment, receiver 32 is responsible for discovering failures and taking corrective action.

In the third level, receiver 32 provides feedback to confirm receipt of all four signals. This allows transmitter 30 to detect the slow or failing receivers and take corrective measures. This level provides the highest level of QoS. Understandably, due to the heavy volume of control and acknowledgment data transmitted, a smaller portion of the system bandwidth will be dedicated to data traffic.

In the following, one or more exemplary embodiments are provided in further detail and with reference to different implementations that provide various levels of QoS. It is noteworthy that these exemplary embodiments should not be construed as limiting the scope of the invention to the particular elements or features discussed below.

For illustrative purposes, we assume that a topic is a named sequence of messages that have a specific order within the context of a transmitter. A topic (i.e., a flow) is mapped to a reliable multicast protocol stream. Many topics may be mapped to the same reliable multicast protocol stream. Each topic that participates in the mapping is associated with a unique “topic ID.” A topic ID can be, for example, an integer or other unique identifier. New topics may be assigned to a topic ID, in response to the topics being added to the mapping.

In one embodiment, a reliable multicast session or stream is implemented by a reliable multicast protocol. A stream may originate from a single source or multiple sources. Data and control packets transmitted over the stream may be sent to a single multicast group, for example. In certain embodiments, multiple streams are sent to a single or multiple multicast groups. A reliable multicast protocol stream, according to one embodiment, supports several communication features comprising (1) transmission reliability, (2) transmission order, (3) message duplication, (4) synchronization delay, and (5) global order.

As noted earlier, a reliable multicast protocol, according to one embodiment, is implemented so that receivers on a stream receive the messages transmitted on that stream with a certain level of reliability (i.e., QoS). As such, any violation of the reliability guaranty, due to the failure of the networking infrastructure, for example, is detected by the receiver. Furthermore, messages are delivered to a receiver, preferably, in the same order in which the messages are transmitted from the transmitter. Also to avoid duplication, preferably, a message is delivered at most once to each receiver in accordance with one embodiment.

For proper synchronization, when a receiver joins a stream, the receiver may not be able to specify or determine the first message received. Therefore, as noted earlier, a series of signals may be transmitted in advance to provide for the proper synchronization of the receiver within a stream. According to one embodiment, messages transmitted on different streams are not ordered, even if the streams originate from the same source.

To support the above features, a transport session identifier may be utilized so that each flow may use one stream as a transport channel, and multiple flows can be transmitted over one stream. This allows for highly granular multiplexing of data and flows can be used to build a topic-based publish/subscribe messaging transport. In some embodiments, a large number of flows are mapped to a limited number of multicast streams, and the streams are mapped to even lesser number of multicast groups. In a dynamic system the mappings may be required to change in order to adapt to changes in the environment.

In one embodiment, the mapping is performed by an optimization process that, given at least one of the data rate of each flow and the user subscription information, attempts to minimize a target cost function (e.g., the excess load on each user). Consequently, the mapping periodically changes, due to changes in flow traffic rate and user interest. As a result, some flows periodically migrate from one stream to another, and some streams migrate from one multicast group to another.

In accordance with one aspect of the invention, to preserve flow message sequencing, maintain the multicast reliability guarantees, and to avoid duplicate transmissions, a reliable multicast protocol uses the closed loop protocol (e.g., a NACK based protocol) having a unidirectional transport at the application programming interface (API) level, as provided in further detail below. In this embodiment, the transmitter has no knowledge of the receivers but responds to retransmission requests (e.g., NACKs) submitted by the receivers.

Referring back to FIG. 2, in an exemplary embodiment, a layer that implements open loop flow and stream migration (OL-Mig) layer is implemented over a reliable multicast protocol. This layer uses the reliable multicast protocol transport and a QoS that corresponds to a NACK based reliable multicast protocol, for example. In this exemplary embodiment, a slow receiver may experience an unrecoverable message loss or lose synchronization with flow or stream migration if the migration signaling messages are not received by the receiver.

In some embodiments, one or more receivers are associated with a transmitter by preferably a unicast connection, for example. Thus, the transmitter has knowledge of the receiver group. In such embodiment, the receivers may provide feedback to the transmitter on the progress of the migration process. Thus, the OL-Mig layer for at least one receiver is implemented to generate reports on the migration state. These reports are transferred to an observer mechanism implemented in the closed loop layer in the receiver side.

The closed loop flow and stream migration (CL-Mig) layer on the receiver side communicates the generated reports to the transmitter (e.g., a broker or server machine). As such, in one embodiment, the OL-Mig layer on the transmitter receives orders from the CL-Mig layer. Thus, information on the progress of the migration can be used to increase the speed and reliability of migration as provided herein.

In one embodiment, the NACK based reliable multicast protocol identifies an event associated with an unrecoverable packet loss and reports the event to an upper layer (e.g., in the form of an exception) so that the upper layer may attempt to recover the loss packets by way of, for example, retransmitting the lost data.

In certain embodiments, a monitoring scheme (e.g., a heartbeat mechanism) is implemented that allows the receivers to monitor the state of the transmitter in real-time. If, for example, a reliable multicast protocol time-out signal is received, the system does not try to recover from such an event. Instead the time-out signal is reported to an upper layer (in the form of an exception, for example). In response, the associated multicast sessions for the multicasting stream may be terminated and the upper layer protocol may attempt to reestablish the session by reinstating the session, for example.

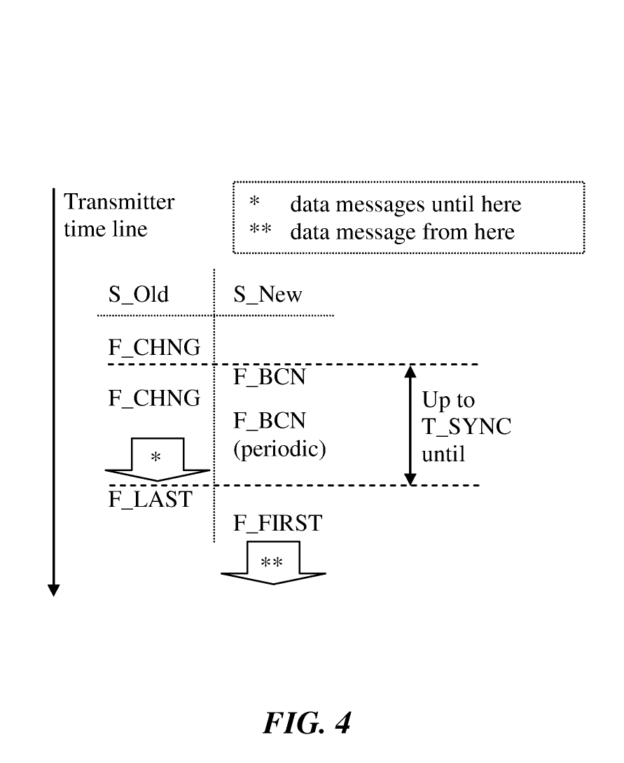

Referring to FIG. 4, in one embodiment, migration of a flow or topic from one stream to the next may be implemented as provided below:

Chng_Sqn: Flow_ID: (S_Old, S_New, G_New): T_Sync: (Meta-data . . . )

where Chng_Sqn is an integer change sequence number, incremented for every change. Flow_ID is a unique integer label for every mapped topic. S_Old is the source stream discussed earlier (i.e., the stream in which the flow is transmitted). S_New is the target stream discussed earlier (i.e., the stream to which the flow is to be migrated).

This is the change specification, which may be sent in one or more of the control messages: F_CHNG, F_BCN, F_LAST, and F_FIRST.

G_New is the multicast group S_New is transmitted on. T_Sync is the time the transmitter waits between the start of the preparation phase and the switch phase. Meta-data is application specific data that is to be transferred to layers on top of the migration layer, in case those layers need to be aware of the flow migration. For example, directions on how to handle client access rights or content filtering.

In an exemplary embodiment, each message transmitted on a stream comprises an integer field called “Stream Version Number” (S_VerNum). This number is added to, for example, data messages as well as control messages. This number may start from zero and is incremented by the transmitter after each change. This number may be incremented on S_Old. The F_LAST control message goes out with an incremented stream version.

A new receiver preferably knows the version number of a new stream it is accepting. A receiver keeps track of the expected version number, and thus can discover if it is out of synch with the transmitter, for example. In one embodiment, the version number is cyclic. Thus, 0 arrives after the maximal positive integer, for example.

In other embodiments, the OL-Mig layer transmitter is controlled using the following application programming interface (API), for example:

int flowChangeStart(Flow_Change_Spec spec)

start the change process, according to spec, return a change sequence number.

void flowChangeSwitch (int Chng_Sqn )

switch between the streams. Prior to this command the upper layer transmits topic ID messages on S_Old; after the command on S_New.

In an exemplary embodiment, the transmitter after a “flowChangeStart” command, periodically sends a message (e.g. F_CHNG) on S_Old. This message includes all the data in the change specification. Preferably, the S_Old name is left out because it is implicit from the stream it was received from. The transmitter then starts sending a periodic “beacon” message on S_New. This message is called F_BCN, for example. This message contains the Chng_Sqn. In order to ensure the safe transition of the clients, the upper layer waits until a predefined time period (e.g., T_SYNC) elapses. During this time, data messages from Flow_ID are transmitted on S_Old, by way of the upper layer, for example.

When a “flowChangeSwitch” command from an upper layer is received, the transmitter stops transmitting the F_CHNG and F_BCN messages and transmits a message (e.g., F_LAST) on S_Old. This message contains the information that appears in the F_CHNG message, for example. Transmitter may then transmit a message (e.g., F_FIRST) on S_New. This message contains the information that appears in the F_CHNG message. Transmitter increment the S_VerNum of S_Old.

It is noteworthy that no Flow_ID messages may be allowed to be submitted on either S_Old or S_New during this action. In one embodiment, the upper layer issues the “flowChangeSwitch” command at a predetermined time. Data messages from Flow_ID are transmitted on S_New, in accordance with one aspect of the invention. The above-described processes may be performed in different orders, depending on implementation.

In one embodiment, one or more data streams may comprise a flag called Data_Accepted. The flag may be of any type. In an exemplary embodiment the flag is Boolean, is preferably initialized as false and is set true when the first reliable multicast protocol data message (e.g., OL-Mig control message) is received from the respective stream.

A stream may be in a closed state (SC), in an open state (SO), and in a data accepted state (DA). A newly opened stream may, for example, transition from close to open to accepted (e.g., SC=>SO=>DA). The receiver scenarios may be differentiated by the following factors: (1) the state of the old stream (e.g., state when the old stream is in the DA state); (2) the state of the new stream (e.g., when the new stream is in the DA state); and (3) the relative order of the control messages between the two streams.

In one embodiment, if state of the old stream is DA at the time the transition starts, the new stream can be in any state (e.g., Sn=SC SO DA). Note that each stream is ordered, thus F_CHNG is followed by F_LAST (i.e., F_CHNG=>F_LAST), and F_BCN is followed by F_FIRST (F_BCN=>F_FIRST). Assuming that one or more of the messages arrive, the possible orderings are:

F_CHNG=>F_BCN=>F_LAST=>F_FIRST

F_CHNG=>F_BCN=>F_FIRST=>F_LAST

F_BCN=>F_CHNG=>F_LAST=>F_FIRST

F_BCN=>F_CHNG=>F_FIRST=>F_LAST

F_CHNG=>F_LAST=>F_BCN=>F_FIRST

F_BCN=>F_FIRST=>F_CHNG=>F_LAST

When accepting a new stream the receiver may not be able to determine with certainty which will be the first message to arrive. Thus, it is possible for the receiver to miss F_BCN, or miss both F_BCN and F_FIRST:

F_CHNG=>F_LAST=>F_FIRST

F_CHNG=>F_FIRST=>F_LAST

F_FIRST=>F_CHNG=>F_LAST

F_CHNG=>F_LAST

Moreover, the receiver may miss both F_BCN and F_FIRST and receive a data message on S_New with Flow_ID, which is an indication of a failure:

F_CHNG=>Data(S_New, Flow_ID)=>F_LAST

F_CHNG=>F_LAST=>Data(S_New, Flow_ID)

In accordance with one embodiment, the old stream may not be in DA when the change starts. This may happen when a change starts after a new subscription is issued by a certain receiver. The receiver may be preparing S_Old for reception by the time the transmitter sends F_CHNG. This may cause the receiver to miss some of the F_CHNG signals on S_Old. If the time between the “prepare” and “switch” stage is long enough, it will allow the receiver to receive at least one F_CHNG message.

Preferably, it is the responsibility of an upper layer to space the preparation and switch stages for the receiver to receive at least one F_CHNG message. In this scenario, the protocol can finish successfully if both F_LAST and F_FIRST are received, in any order. The other signals are there to increase performance and increase the likelihood of success.

In one embodiment, it is possible to miss all the F_CHNG signals and receive an F_LAST signal. This would result in the following scenarios:

F_BCN=>F_LAST=>F_FIRST

F_BCN=>F_FIRST=>F_LAST

F_LAST=>F_BCN=>F_FIRST

As described above, when accepting a new stream, the receiver may not be able to determine which of the above messages will be the first message to arrive. Thus, it is also possible to miss F_BCN, or miss both F_BCN and F_FIRST:

F_LAST=>F_FIRST

F_FIRST=>F_LAST

F_LAST

In certain embodiments, the receiver may miss both F_BCN and F_FIRST and receive a data message on S_New with Flow_ID, which is an indication of a failure as provided below:

F_LAST=>Data(S_New, Flow_ID)

The following scenario may be possible but may not be detected because the receiver may not check for Flow_ID messages on S_New before receiving either F_CHNG, F_LAST, or F_FIRST

Data(S_New, Flow_ID)=>F_LAST

It is also possible that a receiver may miss one or more of the signals from S_Old:

F_BCN=>F_FIRST

F_FIRST

It is also possible that a receiver may lose the control signals, from both streams. This would be caught by the S_VerNum tracking mechanism, for example.

In accordance with one aspect of the invention, the old stream (S_Old) may be in state DA, the new stream (S_New) may be in state SC, and the migration control messages may be received in the order in which they were transmitted (e.g., F_CHNG=>F_BCN=>F_LAST=>F_FIRST). In such a case, upon reception of F_CHNG the receiver checks whether the Flow_IDs specified in the change specification are relevant to the receiver, and processes the meta-data in the message, if any. The receiver then opens resources in order to accept S_New. This may cause the receiver to join G_New, for example. The state of S_New is switched to SO.

In one embodiment, the receivers which subscribe to the flow with Flow_ID on S_Old perform the following procedures. The receiver starts a timer that expires, for example, after A*T_Sync (A>1). Upon the first reception of a message on S_New, the receiver marks the state of that stream as DA. If an observer is registered, the receiver alerts the observer using a callback method. This may cause the upper layer to send a feedback message to the transmitter, indicating that the first phase has been completed (e.g., by way of sending an S_ACCEPT). The accepted message can be a beacon message F_BCN or any other message on that stream, even from a different flow.

Until the receiver receives the F_LAST message which marks the end of transmission of the migrated flow on the old stream, the receiver continues transferring Flow_ID messages form the old stream. Preferably, after the F_LAST message, the receiver stops transferring Flow_ID messages from the old stream and waits for the F_FIRST message on the new stream. After F_FIRST is received, the receiver starts transferring Flow_ID messages from the new stream.

In one embodiment, when the messages that precede F_LAST are delivered, and F_FIRST is received, the receiver completes the transition. The receiver then releases one or more resources that are associated with the old stream in case they are no longer needed. If an observer is registered, the receiver notifies the observer about the event. This may cause the upper layer to send a feedback message to the transmitter, indicating that the second phase has been completed (e.g., by way of an F_CHNG_ACK signal).

In some embodiments, when S_Old is in state DA, S_New is in state SC, and the control messages arrive in the following order:

F_CHNG=>F_BCN=>F_FIRST=>F_LAST

If the F_FIRST message arrives before the F_LAST message, the Flow_ID messages that follow F_FIRST is preferably queued. The receiver waits for the F_LAST message to arrive. When F_LAST arrives, the transition is completed and old resources are closed and the receiver sends F_CHNG_ACK signal. The receiver starts delivering messages from the queue until it is empty or has reached a predetermined threshold, at which time the queue is discarded and normal operations are resumed.

In one embodiment, if both S_Old and S_New are in state DA, the migration control messages are received in the order in which they were transmitted (i.e., F_CHNG=>F_BCN=>F_LAST=>F_FIRST). Upon reception of F_CHNG, the receiver opens a BMF receiver with the new bits. If an observer is registered, the receiver alerts the observer using a callback method. This may cause the upper layer to send a feedback message to the transmitter, indicating that the first phase has been completed (e.g., S_ACCEPT signal).

If S_Old is in state DA, no messages may arrive on the new reliable multicast protocol stream. If the reliable multicast protocol does not time-out, an unrecoverable message loss is not detected. That is, a reliable multicast protocol stream is not accepted when at least one data or control packet is not received. If the A*T_Sync timer expires before S_New goes into DA state, the receiver reports a failure.

In one embodiment, one or more messages transmitted on a stream contain a field (e.g., “Stream Version Number” or (S_VerNum)). This number is added to one or more messages (e.g., data messages, or control messages). This number, preferably, starts from zero and is incremented by the transmitter after each change. This number may be incremented on S_Old. The F_LAST control message goes out with an incremented stream version.

A new receiver preferably determines the version number of a new stream the receiver is accepting. The receiver keeps track of the expected version number, and thus can discover if the receiver is out of sync with the transmitter. After each F_LAST is received, the expected S_VerNum is incremented. The version number is preferably cyclic. Thus 0 arrives after the maximal positive integer, for example.

If the expected version number is lower than the received S_VerNum, it is determined that the receiver has missed a change, and is now risking a loss of data on a certain flow. When a loss of synchronization is detected the appropriate exception is thrown. The receiver can then take corrective action—for example, alert the server and/or close the respective connection.

In one embodiment, a new receiver or a receiver that migrated to a new stream will start receiving messages with a lower stream version than expected. In that case, the receiver throws away those messages, and starts delivering messages when the stream version is advanced to what is expected. The following provides a first receiver state transition table (i.e., Table 4) in accordance with one embodiment:

TABLE 4

| | Current | | Next | | |
|---|---|---|---|---|---|
| | state | Event | state | Action | Remark |
| 1 | Start | Always | Closed | | So - old stream |
| | | | | | Sn - new stream |
| 2 | Closed | Open( So: | Opened | So = SO | The closed state means |
| | | Gx ) | | Opens a | that some other streams |
| | | Open a | | stream | are possibly open but So |
| | | stream So on | | because of | is still closed. That is: |
| | | group Gx. | | some | So = SC; Sn = {SC\|SO\| |
| | | | | subscription | DA} |
| | | | | or flow migration. | |
| 3 | Closed | F_FIRST | S6 | Sn = DA | The Flow-Q process |
| | | (received on | | Start-Timer | queues messages on the |
| | | Sn) | | Start Flow-Q | specified flow, received |
| | | | | process | on Sn. Messages on that |
| | | | | | flow received from So are |
| | | | | | delivered to the |
| | | | | | application. |
| 4 | Opened | DataMsg(So) | Ready | So = DA | The opened state means |
| | | | | | that some other streams |
| | | | | | are possibly open but So |
| | | | | | is still not in DA. That is: |
| | | | | | So = SO; Sn = {SC\|SO\| |
| | | | | | DA} |
| 5 | Opened | F_FIRST | S6 | Sn = DA | |
| | | (received on | | Start-Timer | |
| | | Sn) | | Start Flow-Q | |
| | | | | process | |
| 6 | Opened | F_CHNG | S1 | So = DA | Configure Sn means that |
| | | and Sn != | | Start-Timer | Sn = {SO\|DA} |
| | | DA | | Configure Sn | |
| 7 | Opened | F_CHNG | S2 | So = DA | |
| | | and Sn = DA | | Report( Sn− | |
| | | | | DA ) | |
| | | | | Configure Sn | |
| 8 | Opened | F_LAST and | S5 | So = DA | StopDelivery(So, |
| | | Sn != DA | | Start-Timer | Flow_ID) means stop |
| | | | | Configure Sn | delivering messages on |
| | | | | StopDelivery | the specified flow from |
| | | | | (So,Flow_ID | the old stream to the |
| | | | | ) | application. |
| 9 | Opened | F_LAST and | S3 | So = DA | |
| | | Sn = DA | | Report( Sn− | |
| | | | | DA ) | |
| | | | | Configure Sn | |
| | | | | StopDelivery | |
| | | | | (So,Flow_ID | |
| | | | | ) | |
| 10 | Ready | F_FIRST | S6 | Sn = DA | The ready state means that |
| | | (received on | | Start-Timer | some other streams are |
| | | Sn) | | Start Flow-Q | possibly open and So is in |
| | | | | process | DA. That is: |
| | | | | | So = DA; Sn = {SC\|SO\| |
| | | | | | DA} |
| 11 | Ready | F_CHNG | S1 | Start-Timer | |
| | | and Sn != | | Configure Sn | |
| | | DA | | | |
| 12 | Ready | F_CHNG | S2 | Report( Sn− | |
| | | and Sn = DA | | DA ) | |
| | | | | Configure Sn | |
| 13 | Ready | F_LAST and | S5 | Start-Timer | |
| | | Sn != DA | | Configure Sn | |
| | | | | StopDelivery | |
| | | | | (So,Flow_ID | |
| | | | | ) | |
| 14 | Ready | F_LAST and | S3 | Report( Sn− | |
| | | Sn = DA | | DA ) | |
| | | | | Configure Sn | |
| | | | | StopDelivery | |
| | | | | (So,Flow_ID | |
| | | | | ) | |
| 15 | S1 | F_LAST | S5 | StopDelivery | State S1 means that |
| | | | | (So,F_ID) | F_CHNG was received |
| | | | | | but Sn != DA |
| 16 | S1 | F_BCN or | S2 | Sn = DA | |
| | | DataMsg(Sn, | | Report( Sn− | |
| | | !Flow_ID) | | DA ) | |
| | | | | Stop-Timer | |
| 17 | S1 | F_FIRST | S7 | Sn = DA | |
| | | | | Report( Sn− | |
| | | | | DA ) | |
| | | | | Stop-Timer | |
| | | | | Start Flow-Q | |
| | | | | process | |
| 18 | S1 | Time-Out | Failure | | |
| 19 | S1 | DataMsg(Sn, | Failure | | Receiving a data message |
| | | Flow_ID) | | | with Flow_ID on Sn |
| | | | | | means that F_BCN and |
| | | | | | F_FIRST were lost |
| 20 | S2 | F_FIRST | S7 | Start Flow-Q | State S2 means that |
| | | | | process | F_CHNG was received |
| | | | | | and Sn = DA |
| 21 | S2 | F_LAST | S3 | StopDelivery | |
| | | | | (So,Flow_ID | |
| | | | | ) | |
| 22 | S3 | F_FIRST | S4 | | State S3 means that |
| | | | | | F_LAST was received, |
| | | | | | Sn = DA, and F_FIRST |
| | | | | | was not received. |
| 23 | S4 | Flow-Q not | S4 | Deliver from | State S4 means that |
| | | empty | | Flow-Q | migration was successful |
| | | | | | and all that's left to do is |
| | | | | | to empty the Flow-Q |
| 24 | S4 | Flow-Q | Success | StartDelivery | StartDelivery |
| | | empty | | (Sn,Flow_ID | (Sn, Flow_ID) means |
| | | | | ) | delivering messages on |
| | | | | Discard | the specified flow from |
| | | | | Flow-Q | the new stream to the |
| | | | | Report( | application. |
| | | | | Change-OK | |
| | | | | ) | |
| 25 | S5 | F_FIRST | S4 | Sn = DA | State S5 means that |
| | | | | Report( Sn− | F_LAST was received, |
| | | | | DA ) | but Sn ! = DA. |
| | | | | Stop-Timer | |
| 26 | S5 | F_BCN or | S3 | Sn = DA | |
| | | DataMsg(Sn, | | Report( Sn− | |
| | | !Flow_ID) | | DA ) | |
| | | | | Stop-Timer | |
| 27 | S5 | Time-Out | Failure | Time-Out | |
| 28 | S5 | DataMsg(Sn, | Failure | DataMsg(Sn, | Receiving a data message |
| | | Flow_ID) | | Flow_ID) | with Flow_ID on Sn |
| | | | | | means that F_BCN and |
| | | | | | F_FIRST were lost |
| 29 | S6 | F_CHNG | S7 | Stop-Timer | State S6 means that |
| | | | | | F_FIRST was received |
| | | | | | before F_CHNG and |
| | | | | | F_LAST |
| 30 | S6 | F_LAST | S4 | Stop-Timer | |
| | | | | StopDelivery | |
| | | | | (So,Flow_ID | |
| | | | | ) | |
| 31 | S6 | Time-Out | Failure | | |
| 32 | S7 | F_LAST | S4 | StopDelivery | State S7 means that |
| | | | | (So,Flow_ID | F_FIRST was received |
| | | | | ) | before F_LAST |
| 33 | Any | Reliable | Failure | | Errors such as: |
| | state | multicast | | | unrecoverable packet loss, |
| | | transport | | | heartbeat time-out, etc. |
| | | error report | | | |
| 34 | Any | F_BCN or | Same | Set Sk = DA | Constantly monitor the |
| | state | AnyMsg on | state | | state of open streams |
| | | Sk | | | |

In accordance with one embodiment, the migration of a stream from one multicast group to the next is specified as provided below:

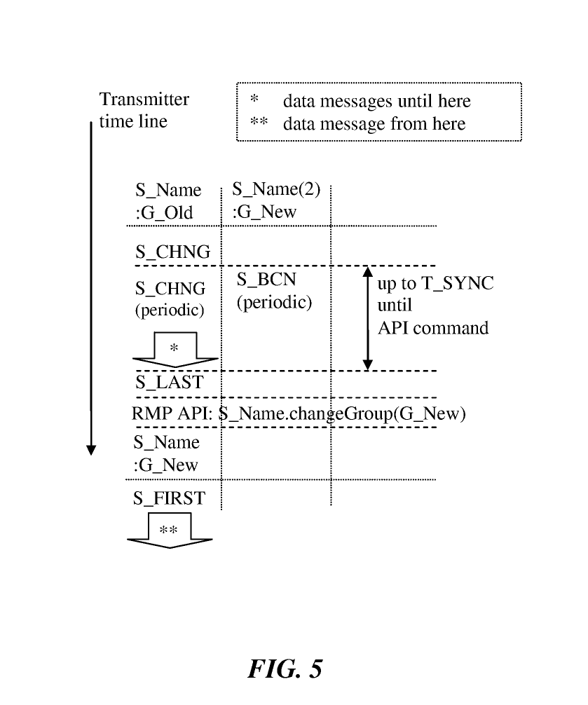

Chng_Sqn: S_Name: (G_Old, G_New): T_Sync: {Meta-data . . . }

Where Chng_Sqn is the integer change sequence number, incremented for every change. S_Name is the stream name. G_Old is the old multicast group. G_New is the new multicast group. (Meta-data . . . ) is application specific data that is to be transferred to layers on top of the migration layer, in case those layers need to be aware of the stream migration. For example, directions on how to handle client access rights or content filtering. Referring to FIG. 5, the change specification may be included in one or more of the four control signals: S_CHNG, S_BCN, S_LAST, and S_FIRST.

The OL-Mig layer may be controlled using the following API:

int streamChangeStart (change spec)

start the change process, according to spec, return a change sequence number

void streamChangeSwitch (Chng_Sqn)

switch between the streams. Prior to this command the upper layer transmits S_Name on G_Old; after the command on G_New.

In one embodiment, the transmitter sends a message (e.g., S_CHNG) on S_Name. This message includes all the data in the change specification. In one embodiment, the S_Name and G_old are omitted because it is implicit from the stream where it was received from. Transmitter starts sending a periodic “beacon” message on G_New (e.g., S_BCN). This message comprises the Chng_Sqn and is sent on a new reliable multicast protocol stream that bears the same name, preferably, (i.e., a new stream with the same name but a different multicast group).

In one embodiment, this stream is opened ad-hoc in the transmitter and closed when the transition completes. This stream may be referred to as S_Name(2). In order to ensure that the safe transition of the receivers, the upper layer may wait up to a predefined time period (e.g., T_SYNCH). During this time, transmitter may continue to transmit data messages on S_Name:G_Old. When a “streamChangeSwitch” command from an upper layer is received, the transmitter stops transmitting the S_CHNG message on S_Name and S_BCN message on S_Name(2) and transmits a message (e.g., S_LAST on S_Name:G Old). This message contains the information contained in S_CHNG, for example.

The transmitter may change the multicast group, the stream transmitter S_Name is transmitting on, to G_New. The transmitter transmits a message called S_FIRST on S_Name:G_New. This message preferably comprises the Chng_Sqn signal. In one embodiment, no data messages are allowed to be submitted on S_Name between S_LAST and S_FIRST. It is the responsibility of the upper layer to issue the “streamChangeSwitch” command at the correct time. Data messages may be transmitted on S_Name:G_New. In certain embodiments, it is possible to change the multicast group that the reliable multicast protocol transmitter is using during run-time.

In one embodiment, the following interface to the stream transmitter is implemented, by way of example:

streamTx.submitMessage (AnyMessageType message)

A method used to submit a message ( of any type).

streamTx.changeGroup (String newMulticastGroupAddress)

A method used to change the multicast group the stream transmitterr is transmiting to.

The last method is a method used to change the multicast group the transmitter uses. The messages that were submitted prior to this method call may be transmitted on the old group, and messages submitted after this method may be transmit on the new group.

In one embodiment, frequency of group changes in smaller than the frequency of message submission. The transmitter can, for example, issue the following code snippet:

. . .

streamTx.submitMessage (message 1)

streamTx.changeGroup (newGroup)

streamTx.submitMessage (message2)

. . .

In one embodiment, the receiver is able to pick up the messages, if it is informed in advance to join the new multicast group.

Referring to FIG. 5, in accordance with another aspect of the invention, the receiver's action is defined such that each group is associated with a flag (e.g., Data_Accepted). This flag in one embodiment is initialized as false and is set to true, for example, when the first RMP data message is received from that group. This may include one or more OL-Mig control messages.

In one embodiment, a group can be in one of three states: a group not joined (GNJ), a group joined (GJ), or a data accepted (DA). A newly joined group can be thus represented by GNJ=>GJ=>DA. The receiver scenarios may be differentiated by three factors: (1) the state of the respective stream on the old group and when the stream is in the DA state; (2) the state of the new group and when the new group is in the DA state; and (3) the relative order of the control messages between the two groups.

In one or more embodiments, the state of the migrated stream on the old group may be DA, at the time the transition starts. This means that the state of the old group is DA at the time the transition starts. The new group may be in any state Gn={GNJ|GJ|DA}. Since each stream is ordered, then the messages on S_Name are ordered, such that F_CHNG=>F_LAST=>F_FIRST. However, F_BCN on S_Name(2) is not synchronized with messages on S_Name. Thus, assuming that one or more messages arrive, the possible orderings are:

S_CHNG=>S_BCN=>S_LAST=>S_FIRST

S_BCN=>S_CHNG=>S_LAST=>S_FIRST

S_CHNG=>S_LAST=>S_BCN=>S_FIRST

S_CHNG=>S_LAST=>S_FIRST=>S_BCN

In some embodiments, it is possible to miss S_BCN, thus: S_CHNG=>S_LAST=>S_FIRST. A failure scenario is when the client cannot receive traffic on G_New. This would result in S_BCN and S_FIRST not being delivered: S_CHNG=>S_LAST=> . . . This may eventually result in a heartbeat timeout on S_Name:G_New, as well as a protocol timeout, whichever comes first.

In another embodiment, the migrated stream (S_Name) on the old group is not in DA when the change starts. This may happen when a change starts right after a new subscription is issued by a certain receiver. That receiver may still be preparing S_Name for reception by the time the transmitter sends S_CHNG. This may cause the receiver to miss some of the S_CHNG signals on S_Name.

Preferably, the time between the “prepare” and “switch” stage is long enough to let such a receiver to receive one of the later S_CHNG messages. In one embodiment, it is the responsibility of an upper layer to space the prepare and switch stages. Because S_LAST contains the information that exists in S_CHNG, even if S_LAST is the first message picked on S_Name, the transition may end successfully.

Accordingly, the protocol can finish successfully if both S_LAST and S_FIRST are received. The other signals are there to enhance performance and increase the likelihood of success. Thus, it is possible to miss all the S_CHNG signals and receive just S_LAST. This would result in the following scenarios:

S_BCN=>S_LAST=>S_FIRST

S_LAST=>S_BCN=>S_FIRST

S_LAST=>S_FIRST=>S_BCN

In some embodiments, it is also possible to miss S_BCN, thus S_LAST=>S_FIRST. As provided earlier, a failure scenario is when the receiver cannot receive traffic on G_New. This may result in S_BCN and S_FIRST not being delivered: S_LAST=> . . . This may eventually result in a heartbeat timeout on S_Name:G_New, as well as a protocol timeout, whichever comes first.

Another failure scenario is when the receiver loses one or more control signals on S_Name, due to the receiver opening S_Name. This results in the heart beats transmitted on S_name:G_New, whereas the receiver listens to S_Name:G_Old. A heartbeat timeout or a first source timeout will indicate this failure.

Some exemplary scenarios associated with receiver actions are provided below with reference to a second receiver transition table (Table 5) in accordance with one aspect of the invention.

TABLE 5

| | Current | | | | |
|---|---|---|---|---|---|
| | state | Event | Next state | Action | Remark |
| 1 | Start | Open( S_Name : Go) | Ready | Join Go. | Assume some |
| | | | | Go = GJ | joined groups - |
| | | | | Opens a | Gk. |
| | | | | stream | Old group is |
| | | | | (S_Name) | Go = {GNJ\| |
| | | | | because of | GJ\|DA}. |
| | | | | some | New group is |
| | | | | subscription, | Gn = {GNJ\| |
| | | | | on group | GJ\|DA}. |
| | | | | Go. | |
| 2 | Ready | S_BCN or DataMsg | Ready | Set Gk = DA | DataMsg is |
| | | on Gk | | | any data |
| | | (In particular on | | | message but |
| | | S_Name:Go). | | | not a migration |
| | | | | | control |
| | | | | | message. |
| 3 | Ready | S_CHNG(Go,Gn) | S1 | Set Go = DA | |
| | | and Gn = {GNJ\|GJ} | | Join Gn, set | |
| | | | | Gn = GJ | |
| | | | | Start-Timer | |
| 4 | Ready | S_CHNG(Go,Gn) | S2 | Set Go = DA | |
| | | and Gn = DA | | Report( Gn− | |
| | | | | DA ) | |
| 5 | Ready | S_LAST and | S3 | Set Go = DA | |
| | | Gn = DA | | Report( Gn− | |
| | | | | DA ) | |
| 6 | Ready | S_LAST and | S5 | Set Go = DA | Joining a |
| | | Gn = {GNJ\|GJ} | | Join Gn, set | group more |
| | | | | Gn = GJ | than once has |
| | | | | Start-Timer | no effect |
| 7 | S1 | S_LAST | S5 | | |
| 8 | S1 | S_BCN or AnyMsg | S2 | Set Gn = DA | |
| | | on Gn | | Stop-Timer | |
| | | | | Report(Gn− | |
| | | | | DA ) | |
| 9 | S1 | Time-Out | Failure | | |
| | | | end state | | |
| 10 | S2 | S_LAST | S3 | If stream | |
| | | | | S_Name is | |
| | | | | the last | |
| | | | | stream on | |
| | | | | Go, leave | |
| | | | | Go | |
| 11 | S3 | S_FIRST | S4 | | State S3 means |
| | | | | | that S_LAST |
| | | | | | had arrived but |
| | | | | | Gn is in DA |
| 12 | S4 | Immediately | Success | Report( | |
| | | | end state | Change-OK | |
| | | | | ) | |
| 13 | S5 | S_BCN | S3 | Set Gn = DA | State S4 means |
| | | | | Stop-Timer | that S_LAST |
| | | | | Report(Gn− | had arrived but |
| | | | | DA) | Gn is not in |
| | | | | | DA |
| 14 | S5 | S_FIRST | S4 | Set Gn = DA | |
| | | | | Stop-Timer | |
| | | | | Report(Gn− | |
| | | | | DA) | |
| 15 | S5 | Time-Out | Failure | | |
| | | | end state | | |
| 16 | Any | Reliable multicast | Failure | | Errors such as: |
| | state | transport error report | end state | | unrecoverable |
| | | | | | packet loss, |
| | | | | | heartbeat time- |
| | | | | | out, etc. |
| 17 | Any | S_BCN or AnyMsg | Same state | Set Gk = DA | Constantly |
| | state | on Gk | | | monitor the |
| | | | | | state of joined groups |

In one embodiment, Go is in state DA, Gn is in state GNJ, and the migration control messages are received in the order in which they were transmitted (i.e., S_CHNG=>S_BCN=>S_LAST=>S_FIRST). Upon reception of S_CHNG the receiver joins the new multicast group. The state of G_New is now GJ. The receiver starts a timer that expires after A*T_Sync (A>1), for example.

Upon the first reception of a S_BCN message on G_New, the receiver marks the state of that group as DA. If an observer is registered, the receiver alerts the observer using a callback method. This may cause the upper layer to send a feedback message to the transmitter (e.g., G_ACCEPT), indicating the completion of the first (prepare) phase. Until the receiver receives the S_LAST message which marks the end of transmission of the migrated stream on the old group, it keeps transferring messages form the old group.

After the S_LAST message the receiver can leave the old group, if no other streams are associated with it, and wait for the S_FIRST message on the new group. After S_FIRST is received, the receiver starts transferring messages from the new group. At this stage the receiver may complete the transition. If an observer is registered, the receiver notifies the observer of that event. This may cause the upper layer to send a feedback message to the transmitter (e.g., S_CHNG_ACK), indicating the completion of the second (switch) phase.

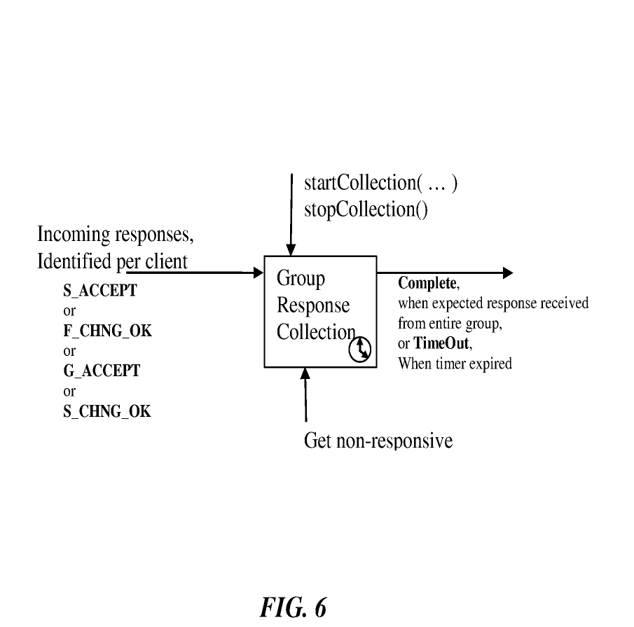

In accordance with another aspect of the invention, a closed loop migration protocol is implemented based upon the knowledge of the receiver group affected by the change, and the collection of feedback from those receivers to provide an additional level of reliability and control to the migration process. In some embodiments, a change is related to a group of subscribers, or receivers. Preferably the receivers are identifiable. Thus, in one embodiment, before a change begins, the affected receiver group is calculated, and fed into a mechanism that collects group responses, as illustrated in FIG. 6.

The mechanism is set to expect a type of response. A response may comprise the change sequence number to which the response relates, and the identity of the receiver that sent the response. The mechanism is configured to take into account responses bearing a certain sequence number. The mechanism provides an indication of when the entire group provides the desired response. The mechanism may be implemented to provide the list of group members that have not responded until a certain time has passed.

In one embodiment, the receiver group is updated while the mechanism collects the responses. This real-time update is useful, for example, when a receiver leaves or joins the group. In some embodiments, real-time update is not performed because the timeout mechanism ensures that the migration process will eventually terminate by avoiding any deadlocks. The update procedure can increase performance and should be considered when taking into account other implementation trade-offs. A discrepancy between the expected receiver group and the collection of incoming responses will result in a timeout and can be resolved after the timeout by the upper layer, for example.

An exemplary API for the above-noted mechanism is provided below:

registerEventListener (EventListener)

startCollection (ClientGroup, ResponseType, ChngSqn, TimeOut)

EventListener.complete (ResponseType, ChngSqn)

EventListener.timeout (ResponseType, ChngSqn, NonResponsiveMembers)

stopCollection( )

getNonResponsiveMembers( )

clear( )

updateGroup(TBD)

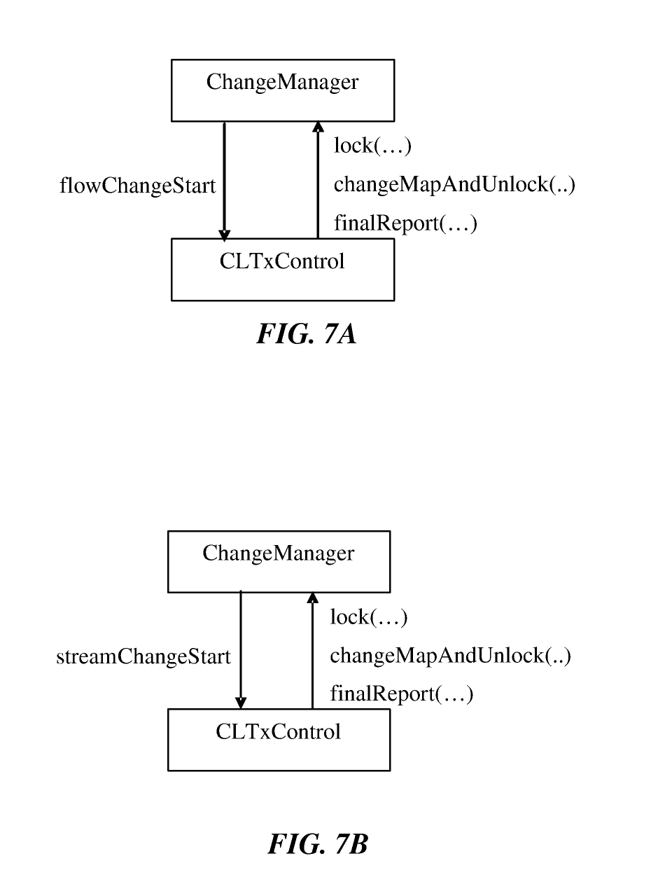

Referring to FIG. 7A, during flow migration, a receiver group in accordance with one embodiment is calculated by an upper layer and given to the CL-Mig layer. The change specification including any meta-data is prepared by an upper layer and given to the CL-Mig layer.

The following is an exemplary transmitter API, implemented in accordance with one embodiment, wherein the call starts the change process, and returns a change sequence number, in accordance with one embodiment.

int CLTxControl.flowChangeStart (CLFlowChangeSpec spec, List clientList, ChangeManager manager)

CLTxControl is the entity that controls the closed-loop change process on the transmitter side.

CLFlowChangeSpec is a data structure holding the closed loop change spec.

clientList is a list of receiver identities, from which responses should be collected, using the group response collection mechanism. If the list is null or empty, assume open loop protocol (i.e. time the switch according to the timeout mechanism).

ChangeManager is a listener (or observer) implemented by the upper layer.

The following method calls are called by the transmitter closed loop layer (CLTxControl) in order to notify the upper layer (that implements ChangeManager) about the progress of the migration phases, in accordance with one embodiment:

ChangeManager.lock(int ChngSqn)

ChangeManager is an entity implemented by a layer above the closed loop migration layer, for example. This method is called by the CLTxControl before issuing the switch to the OL-Mig layer. Lock message submission on the respective flow. This will be followed by the switch issued to the OL-Mig.

ChangeManager.changeMapAndUnlock (int ChngSqn)

This method is called by the CL-Tx after issuing the switch to the OL-Mig layer. The manager will change the mapping of the respective flow, and unlock message submission to the respective flow.

ChangeManager.finalReport (int ChngSqn, List nonResponsiveClientConnectionList, Throwable status)

The closed loop layer will report to the manager either after all the responses were collected, or a time out was thrown. Exceptions in the lower layers are also reported. This report completes the change process of one flow.

In one embodiment, the transmitter sets the GRC (Group Response Collection) mechanism to collect the S_ACCEPT messages, chng_sqn, set timeout, and set group members. When one or more group members acknowledge the reception of the new stream, or, in case the GRC mechanism indicates that the timer has elapsed, the transmitter may indicate to the upper layer to take the “ChangeLock” in order to prevent incoming messages from being submitted to the respective stream before the switch phase is over and set the GRC mechanism to collect final acknowledge messages (e.g., F_CHNG_OK). This includes setting a new timer.

In some embodiments, the transmitter may Issue the OL-Mig “switch” command (this will: Send the F_LAST on S_Old, Send F_FIRST on S_New) and indicate to the upper layer to change the mapping and unlock the “ChangeLock”. The transmitter preferably waits for acknowledgements. If one or more of the group acknowledges finish with success, the transmitter may report to the upper layer.

In one embodiment, if the timer expires before one or more of the receivers acknowledge, the transmitter may report to the upper layer on the partial completion. This will cause the upper layer to close the receiver connections that did not acknowledge the change. The receiver may transmit one or more reports from the OL-Mig layer to the transmitter using the dedicated unicast transport, and report protocol failures to the layer above the closed loop receiver control.

Referring to FIG. 7B, during stream migration, a receiver group is calculated by an upper layer and given to the CL-Mig layer, in accordance with one embodiment. Preferably, the change specification is prepared by an upper layer and given to the CL-Mig layer. The following is an exemplary transmitter API implemented in accordance with one embodiment:

int CLTx.streamChangeStart (CLStreamChangeSpec spec, List clientList, ChangeManager manager)

CLTxControl is the entity that controls the closed-loop change process on the transmitter side.

CLStreamChangeSpec is a data structure holding the closed loop change spec.

ClientList is a list of receiver identities, from which responses should be collected using the group response collection mechanism. If the list is null or empty, assume open loop protocol, i.e. time the switch according to the timeout mechanism.

ChangeManager is a listener (or observer) implemented by the upper layer.

This method call starts the change process, and returns a change sequence number.

ChangeManager.lock(int ChngSqn)

ChangeManager is an entity implemented by a layer above the closed loop migration layer. This method is called by the CLTxControl before issuing the switch to the OL-Mig layer. Lock message submission on the respective stream. This will be followed by the switch issued to the OL-Mig.

ChangeManager.changeMapAndUnlock(int ChngSqn)

This is called by CLTxControl after issuing the switch to the OL-Mig layer. The manager will change the mapping of the respective stream, and unlock message submission to the respective stream.

ChangeManager.finalReport (int ChngSqn, List nonResponsiveClientConnectionList, Throwable status)

The closed loop layer will report to the manager either after all the responses were collected, or a time out was thrown. Exceptions in the lower layers are also reported. This report completes the change process of one stream.

In accordance with one embodiment, the transmitter may set the GRC mechanism to collect the G_ACCEPT messages, chng_sqn, set timeout, set group members, and start an OL-Mig stream migration. When one or more of the group members acknowledge the reception of the new group or, when the GRC mechanism indicates that the timer has elapsed, the transmitter performs one or more of the following actions:

(1) Indicate to the upper layer to take the “ChangeLock” in order to prevent incoming messages from being submitted to the respective stream before the switch phase is over; (2) Set the GRC mechanism to collect final acknowledgement messages (e.g., S_CHNG_OK); (3) Issue the OL-Mig “switch” command (e.g., send the S_LAST on G_Old, change group, and Send S_FIRST on G_New); and (4) Indicate to the upper layer to change the mapping and unlock the “ChangeLock”

In certain embodiments, the transmitter preferably waits for acknowledgements from the receivers. If the receivers acknowledge a successful finish, the transmitter reports the success to the upper layer. If timer expires before the receivers acknowledge, the transmitter reports the same to the upper layer on the partial completion. This will cause the upper layer to close the receiver connections that did not acknowledge the change.

In one embodiment, the receiver transmits one or more reports from the OL-Mig layer to the transmitter, using a dedicated unicast transport. The receiver may join new multicast groups when the information is available. However, the action of leaving an old multicast group to which the receiver is no longer required to listen may be deferred until after the respective S_LAST message is received on the migrated stream.

In accordance with another aspect of the invention, when a new map is available, the difference between the old and new maps may be broken into a sequence of partial changes. Each partial change, or a step, may be either a flow or a stream migration. Preferably, the partial changes are executed sequentially. In some embodiments, partial changes are made concurrent and batch several changes, as provided in more detail below.

In one embodiment, when two flow migrations are independent (e.g., the source and target streams comprise four different streams such that two flow changes can take place concurrently without changes to the basic protocol), if the source and target streams overlap fully or partially, some degree of synchronization and coordination is implemented.

In certain embodiments, the actions the receiver may take in response to a migration protocol control message are independent with respect to one another. Preferably, in the transmitter, the flowChangeStart, lock, changeMapAndUnlock, and finalReport methods, are also independent with respect to one another. When two stream migrations are independent (e.g., the source and target groups comprise four different groups, such that the two flow changes can take place concurrently without changes to the basic protocol), if the source and target groups overlap fully or partially, some degree of synchronization and coordination is implemented.

In one or more embodiments, several different flows are migrated from the same source stream onto the same target stream. It is possible to unite the control messages of all these changes by modifying the change specification as provided in the following example:

Chng_Sqn: {Flow_ID_{—}1, Flow_ID_{—}2, . . . , Flow_ID_k}: (S_Old, S_New, G_New): T_Sync: {Meta-data_{—}1, Meta-data_{—}2, . . . Meta-data_k}

One or more of the flow changes are preferably executed together, and given a single change sequence number. In this embodiment, the protocol behaves as if migrating a single flow.

In certain embodiments, different streams are migrated from the same source group onto the same target group. It is possible to unite the control messages of one or more of these changes by modifying the change specification in accordance with the following example:

Chng_Sqn: {S_Name_{—}1, S_Name_{—}2, . . . , S_Name_k}: (G_Old, G_New): T_Sync: {Meta-data_{—}1, Meta-data_{—}2, . . . , Meta-data_k}

One or more of the stream changes are preferably executed together, and given a single change sequence number. In this embodiment, the protocol behaves as if migrating a single stream.

In different embodiments, the invention can be implemented either entirely in the form of hardware, software, or a combination of both hardware and software. For example, receiver 32 and transmitter 30 may comprise a controlled computing system environment that can be presented largely in terms of hardware components and software code executed to perform processes that achieve the results contemplated by the system of the present invention.

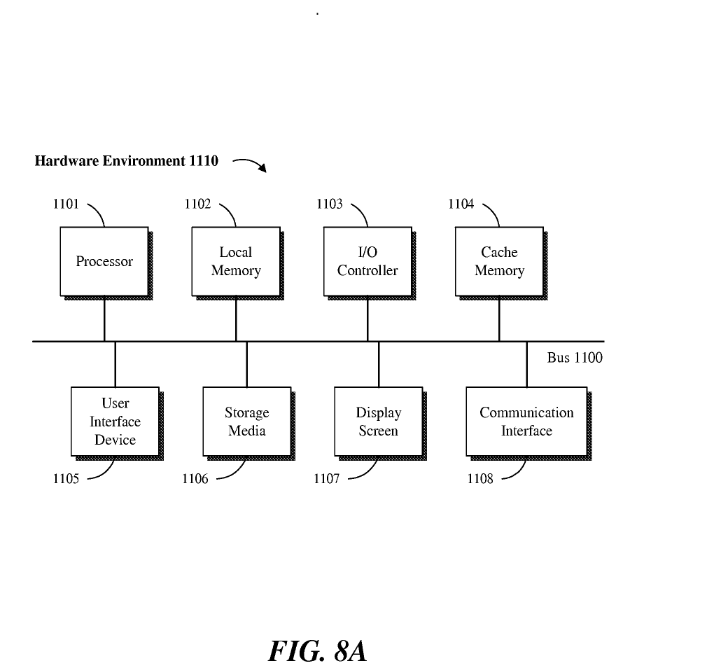

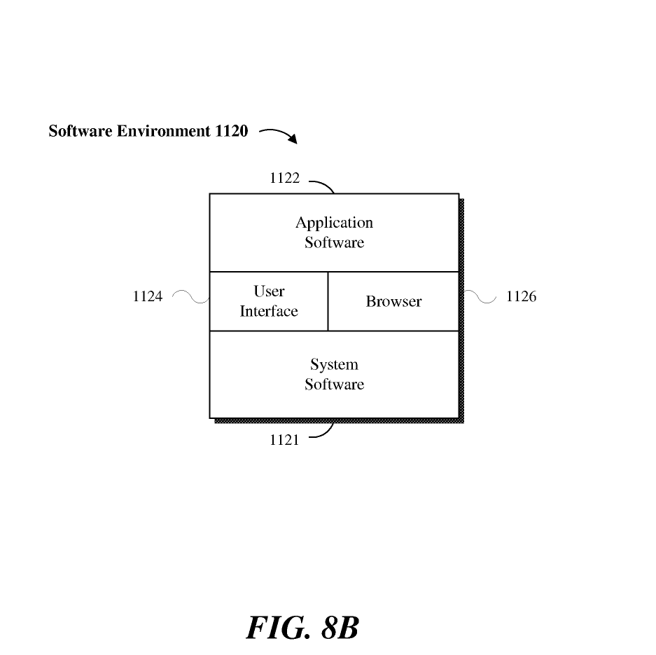

Referring to FIGS. 8A and 8B, a computing system environment in accordance with an exemplary embodiment is composed of a hardware environment 1110 and a software environment 1120. The hardware environment 1110 comprises the machinery and equipment that provide an execution environment for the software, and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes, comprising system software 1121 and application software 1122. System software 1121 comprises control programs, such as the operating system (OS), and information management systems that instruct the hardware on how to function and process information.

In one embodiment, a software application running on receiver 32 and transmitter 30 is implemented as application software 1122 executed on one or more hardware environments to facilitate migration of message topics over multicast topics and groups, as provided earlier. Application software 1122 may comprise but is not limited to program code, data structures, firmware, resident software, microcode or any other form of information or routine that may be read, analyzed or executed by a microcontroller.

In an alternative embodiment, the invention may be implemented as a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include semiconductor or solid-state memory, magnetic tapes, removable computer diskettes, random access memory (RAM), read-memory (ROM), rigid magnetic disks, and optical disks. Current examples of optical disks include compact disk read only memory (CD-ROM), compact disk read/write (CD-RWW) and digital video disk (DVD).

Referring to FIG. 8A, an embodiment of the application software 1122 can be implemented as computer software in the form of computer readable code. This code can be executed on a data processing system such as hardware environment 1110 that comprises a processor 1101 coupled to one or more memory elements by way of a system bus 1100. The memory elements, for example, can comprise local memory 1102, storage media 1106, and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system, such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 8B, application software 1122 can comprise one or more computer programs that are executed on top of system software 1121 after being loaded from storage media 1106 into local memory 1102. In a client-server architecture, application software 1122 may comprise client software and server software. For example, in one embodiment of the invention, client software is executed on computing system 100, and server software is executed on a server system (not shown).

Software environment 1120 may also comprise browser software 1126 for accessing data available over local or remote computing networks. Further, software environment 1120 may comprise a user interface 1124 (e.g., a Graphical User Interface (GUI)) for receiving user commands and data. Please note that the hardware and software architectures and environments described above are for exemplary purposes, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps can be performed in any order or in parallel, unless indicated otherwise in the present disclosure. Further, the logic code is not related or limited to any particular programming language, and may comprise of one or more modules that execute on one or more processors in a distributed, non-distributed or multiprocessing environment.

The present invention has been described above with reference to preferred features and embodiments. Those skilled in the art will recognize, however, that changes and modifications may be made in these preferred embodiments without departing from the scope of the present invention. These and various other adaptations and combinations of the embodiments disclosed are within the scope of the invention and are further defined by the claims and their full scope of equivalents.

What is claimed is:

1. A method for migrating data transmitted from a transmitter to a receiver over a first stream to a second stream in a reliable multicast system, the method comprising:
transmitting a first message from the transmitter to the receiver over the first stream to notify the receiver that a first data flow transmitted on the first stream will be transmitted on the second stream; and
transmitting the first data flow on the second stream after a first threshold has expired.

2. The method of claim 1 further comprising transmitting a second message from the transmitter to the receiver over the second stream after a second threshold has expired, wherein the transmitter and the receiver synchronize communication of the first data flow over the second stream based on the second message.

3. The method of claim 2, wherein the second message comprises a beacon allowing the receiver to synchronize flow of date over the second stream.

4. The method of claim 2 further comprising transmitting a third message from the transmitter to the receiver over the first stream after a third threshold has expired to notify the receiver that transmission of the first data flow over the first stream will be terminated.

5. The method of claim 4, wherein the third message indicates end transmission of the first data flow over the first stream.

6. The method of claim 4 further comprising transmitting a fourth message from the transmitter to the receiver over the second stream after a fourth threshold has expired to indicate to the receiver successful migration of the first data flow from the first stream to the second stream.

7. The method of claim 1, wherein the first data flow comprises a plurality of topics.

8. The method of claim 1, wherein the receiver provides feedback to the transmitter to indicate status of receipt of the first message.

9. The method of claim 8, wherein the first data flow is transmitted over the second stream, in response to the transmitter receiving the feedback from the receiver, if the first threshold has not yet expired.

10. The method of claim 2, wherein the receiver provides feedback to the transmitter to indicate status of receipt of the second message.

11. The method of claim 10, wherein the first data flow is transmitted over the second stream, in response to the transmitter receiving the feedback from the receiver, if the first threshold has not yet expired.

12. The method of claim 4, wherein the receiver provides feedback to the transmitter to indicate status of receipt of the third message.

13. The method of claim 12, wherein the first data flow is transmitted over the second stream, in response to the transmitter receiving the feedback from the receiver, if the first threshold has not yet expired.

14. The method of claim 6, wherein the receiver provides feedback to the transmitter to indicate status of receipt of the fourth message.

15. The method of claim 14, wherein the first data flow is transmitted over the second stream, in response to the transmitter receiving the feedback from the receiver, if the first threshold has not yet expired.

16. A system for migrating data transmitted from a transmitter to a receiver over a first stream to a second stream in a reliable multicast system, the system comprising:
logic unit for transmitting a first message from the transmitter to the receiver over the first stream to notify the receiver that a first data flow transmitted on the first stream will be transmitted on the second stream;
logic unit for transmitting a second message from the transmitter to the receiver over the second stream after a second threshold has expired, wherein the transmitter and the receiver synchronize communication of the first data flow over the second stream based on the second message;
logic unit for transmitting a third message from the transmitter to the receiver over the first stream after a third threshold has expired to notify the receiver that transmission of the first data flow over the first stream will be terminated; and
logic unit for transmitting a fourth message from the transmitter to the receiver over the second stream after a fourth threshold has expired to indicate to the receiver successful migration of the first data flow from the first stream to the second stream.

17. The system of claim 16 further comprising logic unit for transmitting the first data flow on the second stream after a first threshold has expired.

18. The system of claim 17, wherein the receiver provides feedback to the transmitter to indicate status of receipt of at least one of the first, second, third and fourth messages.

19. The system of claim 18, wherein the first data flow is transmitted on the second stream after the transmitter receives the feedback provided by the receiver, if the first threshold has not yet expired.

20. A method for migrating a data stream transmitted from a transmitter to a receiver in a first multicast group, the method comprising:
transmitting a first message from the transmitter to the receiver in the first multicast group to notify the receiver that a first data stream transmitted to the first multicast group will be transmitted to a second multicast group; and
transmitting the first data stream to the second multicast group after a first threshold has expired.
